(19) United States
(12) Patent Application Publication
(10) Pub. No.: US 2022/0375094 A1
(43) Pub. Date: Nov. 24, 2022

(54) OBJECT RECOGNITION APPARATUS, OBJECT RECOGNITION METHOD AND LEARNING DATA

(71) Applicant: FUJIFILM Toyama Chemical Co., Ltd., Tokyo (JP)

(72) Inventors: Kazuchika IWAMI, Ashigarakami-gun (JP); Shinji Haneda, Tokyo (JP)

(73) Assignee: FUJIFILM Toyama Chemical Co., Ltd., Tokyo (JP)

(21) Appl. No.: 17/882,979

(22) Filed: Aug. 8, 2022

Related U.S. Application Data
(63) Continuation of application No. PCT/JP2021/004195, filed on Feb. 5, 2021.

(30) Foreign Application Priority Data
Feb. 14, 2020 (JP) 2020-023743

(51) Int. Cl. G06T 7/12; G06V 10/774; G06T 7/194; G06V 10/22; G06V 20/60

(52) U.S. Cl. CPC G06T 7/12; G06V 10/774; G06T 7/194; G06V 10/225; G06V 20/60; G06T 2207/20081; G06T 2207/10024

(57) ABSTRACT

An image acquiring unit of acquires a captured image in which two or more medicines of a plurality of objects (medicines) are in point-contact or line-contact with one another. A first recognizer receives the captured image and generates an edge image indicating only a part where medicines are in point-contact or line-contact with one another, in the captured image. A second recognizer receives the captured image and the edge image, recognizes each of the plurality of medicines from the captured image, and outputs a recognition result. Since the second recognizer receives edge image indicating only the part where medicines are in point-contact or line-contact useful for separating the areas of the medicines, even if two or more medicines of the plurality of medicines are in point-contact or line-contact with one another, it is possible to accurately separate and recognize the areas of the plurality of medicines from the captured image.

### CROSS-REFERENCE TO RELATED APPLICATIONS

The present application is a Continuation of PCT International Application No. PCT/JP2021/004195 filed on Feb. 5, 2021 claiming priority under 35 U.S. § 119(a) to Japanese Patent Application No. 2020-023743 filed on Feb. 14, 2020. Each of the above applications is hereby expressly incorporated by reference, in its entirety, into the present application.

### BACKGROUND OF THE INVENTION

1. Field of the Invention

The present invention relates to an object recognition apparatus, an object recognition method, a program, and learning data. More particularly, the present invention relates to a technique to recognize individual objects from a captured image in which a plurality of objects are imaged, even in a case where two or more objects of the plurality of objects are in point-contact or line-contact with one another.

2. Description of the Related Art

Japanese Patent Application Laid-Open No. 2019-133433 (hereinafter referred to as “Patent Literature 1”) describes an image processing apparatus which accurately detects boundaries of areas of objects, in segmentation of a plurality of objects using machine learning.

The image processing apparatus described in Patent Literature 1 includes: an image acquiring unit configured to acquire a processing target image (image to be processed) including a subject image which is a segmentation target; an image feature detector configured to generate an emphasized image in which a feature of the subject image learned from a first machine learning is emphasized using a mode learned from the first machine learning; and a segmentation unit configured to specify by segmentation, an area corresponding to the subject image using a mode learned from a second machine learning, based on the emphasized image and the processing target image.

Specifically, the image feature detector generates an emphasized image (edge image) in which the feature of the subject image learned from the first machine learning is emphasized using the mode learned from the first machine learning. The segmentation unit receives the edge image and the processing target image, and specify by segmentation, the area corresponding to the subject image using the mode learned from the second machine learning. Thus, the boundary between the areas of the subject image can be accurately detected.

### Citation List

Patent Literature 1: Japanese Patent Application Laid-Open No. 2019-133433

### SUMMARY OF THE INVENTION

The image processing apparatus described in Patent Literature 1 generates, separately from the processing target image, the emphasized image (edge image) in which the feature of the subject image in the processing target image is emphasized, uses the edge image and the processing target image as input images, and extracts the area corresponding the subject image. However, the process presupposes that the edge image can be appropriately generated.

In addition, in a case in which a plurality of objects are in contact with one another, it is difficult to recognize an object to which each edge belongs.

For example, in a case in which a plurality of medicines for one dose are objects, in particular, in a case in which a plurality of medicines are put in one medicine pack, the medicines are often in point-contact or line-contact with one another.

In a case in which a shape of each of the medicines in contact with one another is unknown, even if an edge of each medicine is detected, it is difficult to determine whether the edge is an edge of a target medicine or an edge of another medicine. In the first place, the edge of each medicine is not always clearly shown (imaged).

Hence, in a case in which all or some of a plurality of medicines are in point-contact or line-contact with one another, it is difficult to recognize an area of each medicine.

The present invention has been made in light of such a situation, and aims to provide an object recognition apparatus, an object recognition method, a program and learning data which can accurately recognize individual objects from a captured image in which a plurality of objects are imaged.

To achieve the above object, an object recognition apparatus according to a first aspect of the invention, includes a processor, and recognizes by using the processor, each of a plurality of objects from a captured image in which images of the plurality of objects are captured, wherein the processor is configured to perform: an image acquiring process to acquire the captured image in which two or more objects of the plurality of objects are in point-contact or line-contact with one another; an edge-image acquiring process to acquire an edge image indicating only a part where the two or more objects are in point-contact or line-contact with one another in the captured image; and an output process to receive the captured image and the edge image, recognize each of the plurality of objects from the captured image, and output a recognition result.

With the first aspect of the present invention, in a case in which each of the plurality of objects are recognized from a captured image in which images of a plurality of objects are captured, the feature amounts of a part where objects are in point-contact or line-contact with one another are taken into account. Specifically, in a case where the processor acquires a captured image in which two or more objects of the plurality of objects are in point-contact or line-contact with one another, the processor acquires an edge image indicating only a part where the two or more objects are in point-contact or line-contact with one another in the acquired captured image. Then, the processor receives the captured image and the edge image, recognizes each of the plurality of objects from the captured image, and outputs a recognition result.

In an object recognition apparatus according to a second aspect of the present invention, it is preferable that the processor include a first recognizer configured to perform the edge-image acquiring process, and in a case where the first recognizer receives a captured image in which two or more objects of the plurality of objects are in point-contact or line-contact with one another, the first recognizer outputs an edge image indicating only the part where the two or more objects are in point-contact or line-contact with one another in the captured image.

In an object recognition apparatus according to a third aspect of the present invention, it is preferable that the first recognizer be a first machine-learning trained model trained by machine learning based on first learning data including pairs of a first learning image and first correct data. The first learning image is a captured image which includes a plurality of objects and in which two or more objects of the plurality of objects are in point-contact or line-contact with one another, and the first correct data is an edge image indicating only a part where two or more objects are in point-contact or line-contact with one another in the first learning image.

In an object recognition apparatus according to a fourth aspect of the present invention, it is preferable that the processor include a second recognizer configured to receive the captured image and the edge image, recognize each of the plurality of objects included in the captured image, and output a recognition result.

In an object recognition apparatus according to a fifth aspect of the present invention, it is preferable that the second recognizer be a second machine-learning trained model trained by machine learning based on second learning data including pairs of a second learning image and second correct data. Each of the second learning image has: a captured image which includes a plurality of objects and in which two or more objects of the plurality of objects are in point-contact or line-contact with one another; and an edge image indicating only the part where medicines are in point-contact or line-contact with one another in the captured image. Each of the second correct data is area information indicating areas of the plurality of objects in the captured image.

In an object recognition apparatus according to a sixth aspect of the present invention, it is preferable that the processor include a third recognizer, that the processor receive the captured image and the edge image, and performs image processing that replaces a part in the captured image corresponding to the edge image with a background color of the captured image, and that the third recognizer receive the captured image which has been subjected to the image processing, recognize each of the plurality of objects included in the captured image, and output a recognition result.

In an object recognition apparatus according to a seventh aspect of the present invention, preferably in the output process, the processor output, as the recognition result, at least one of: a mask image for each object image indicating each object, the mask image to be used for a mask process to cut out each object image from the captured image; bounding box information for each object image, which surrounds an area of each object image with a rectangle; and edge information for each object image, which indicates an edge of the area of each object image.

In an object recognition apparatus according to an eighth aspect of the present invention, it is preferable that the plurality of objects be a plurality of medicines. The plurality of medicines are, for example, a plurality of medicines for one dose packaged in a medicine pack, a plurality of medicines for a day, a plurality of medicines for one prescription, or the like.

A ninth aspect of the invention is learning data including pairs of a first learning image and first correct data, in which the first learning image is a captured image which includes a plurality of objects and in which two or more objects of the plurality of objects are in point-contact or line-contact with one another, and the first correct data is an edge image indicating only a part where medicines are in point-contact or line-contact with one another in the first learning image.

A tenth aspect of the invention is learning data including pairs of a second learning image and second correct data, wherein the second learning image has: a captured image which includes a plurality of objects and in which two or more objects of the plurality of objects are in point-contact or line-contact with one another; and an edge image indicating only a part where medicines are in point-contact or line-contact with one another in the captured image, and the second correct data is area information indicating areas of the plurality of objects in the captured image.

An eleventh aspect of the invention is an object recognition method of recognizing each of a plurality of objects from a captured image in which images of the plurality of objects are captured, the method including: acquiring, by a processor, the captured image in which two or more objects of the plurality of objects are in point-contact or line-contact with one another; acquiring an edge image indicating only a part where medicines are in point-contact or line-contact with one another in the captured image; and receiving the captured image and the edge image, recognizing each of the plurality of objects from the captured image, and outputting a recognition result.

In an object recognition method according to a twelfth aspect of the present invention, preferably in the outputting the recognition result, at least one of: a mask image for each object image indicating each object, the mask image to be used for a mask process to cut out each object image from the captured image; bounding box information for each object image, which surrounds an area of each object image with a rectangle; and edge information for each object image, which indicates an edge of the area of each object image, is output as the recognition result.

In an object recognition method according to a thirteenth aspect of the present invention, it is preferable that the plurality of objects be a plurality of medicines.

A fourteenth aspect of the invention is an object recognition program for causing a computer to execute: a function of acquiring a captured image which includes a plurality of objects and in which two or more objects of the plurality of objects are in point-contact or line-contact with one another; a function of acquiring an edge image indicating only a part where medicines are in point-contact or line-contact with one another in the captured image; and a function of receiving the captured image and the edge image, recognizing each of the plurality of objects from the captured image, and outputting a recognition result. Further, the program may be recorded on a non-transitory computer-readable, tangible recording medium. The program may cause, when read by a computer, the computer to perform the object recognition method according the eleventh to thirteenth aspect of the present invention.

With the present invention, it is possible to recognize, with high accuracy, individual objects in which two or more objects of a plurality of objects are in point-contact or line-contact with one another from a captured image in which images of the plurality of objects are captured.

### BRIEF DESCRIPTION OF THE DRAWINGS

FIG. 1 is a block diagram illustrating an example of a hardware configuration of an object recognition apparatus according to the present invention.

FIG. 2 is a block diagram illustrating a schematic configuration of an imaging apparatus illustrated in FIG. 1.

FIG. 3 is a plan view of three packages each of which includes a plurality of medicines;

FIG. 4 is a plan view illustrating a schematic configuration of the imaging apparatus.

FIG. 5 is a side view illustrating a schematic configuration of the imaging apparatus.

FIG. 6 is a block diagram of an object recognition apparatus according to a first embodiment of the present invention.

FIG. 7 is a diagram illustrating an example of a captured image acquired by an image acquiring unit.

FIG. 8 is a diagram illustrating an example of an edge image acquired by a first recognizer, the edge image indicating only the parts where medicines are in point-contact or line-contact with one another.

FIG. 9 is a schematic diagram illustrating an example of a typical configuration of a CNN which is one example of a trained model constituting a second recognizer (second trained model).

FIG. 10 is a schematic diagram illustrating an example of a configuration of an intermediate layer in the second recognizer illustrated in FIG. 9.

FIG. 11 is a diagram illustrating an example of a recognition result by the second recognizer.

FIG. 12 is a diagram illustrating an object recognition process by R-CNN.

FIG. 13 is a diagram illustrating a mask image of a medicine recognized by Mask R-CNN.

FIG. 14 is a block diagram of an object recognition apparatus according to a second embodiment of the present invention.

FIG. 15 is a diagram illustrating a captured image after image processing by an image processing unit.

FIG. 16 is a flowchart showing an object recognition method according to embodiments of the present invention.

### DESCRIPTION OF THE PREFERRED EMBODIMENTS

Preferred embodiments of an object recognition apparatus, an object recognition method and a program, and learning data according to the present invention are described below with reference to the attached drawings.

[Configuration of Object Recognition Apparatus]

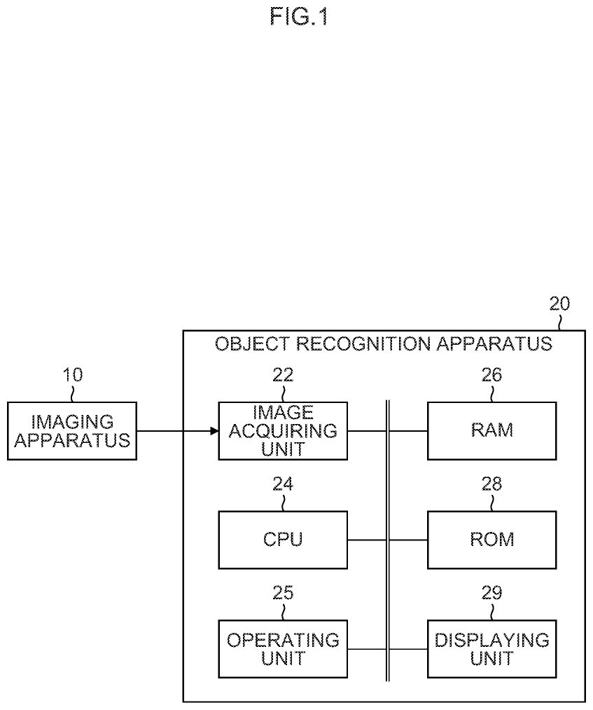

FIG. 1 is a block diagram illustrating an example of a hardware configuration of an object recognition apparatus according to the present invention.

The object recognition apparatus 20 illustrated in FIG. 1 can be configured, for example, by using a computer. The object recognition apparatus 20 mainly includes an image acquiring unit 22, a central processing unit (CPU) 24, an operating unit 25, a random access memory (RAM) 26, a read only memory (ROM) 28, and a displaying unit 29.

The image acquiring unit 22 acquires from the imaging apparatus 10, a captured image in which objects are imaged by an imaging apparatus 10.

The objects imaged by the imaging apparatus 10 are a plurality of objects present within the image-capturing range, and the objects in this example are a plurality of medicines for one dose. The plurality of medicines may be ones put in a medicine pack or ones before they are put in a medicine pack.

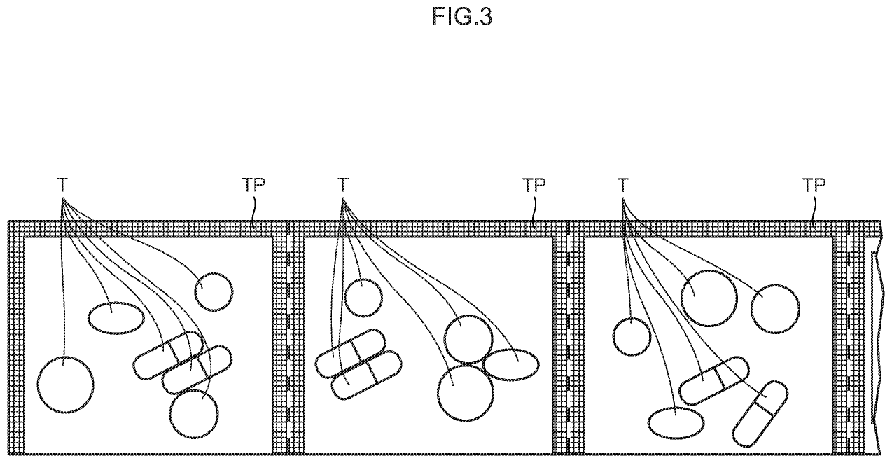

FIG. 3 is a plan view of three medicine packs in each one of which a plurality of medicines are packed.

Each medicine pack TP illustrated in FIG. 3 has six medicines T packed therein. In FIG. 3, as for the six medicines T in the left medicine pack TP or the central medicine pack TP, all or some of the medicines of the six medicines T are in point-contact or line-contact with one another, and the six medicines in the right medicine pack TP in FIG. 3 are all apart from one another.

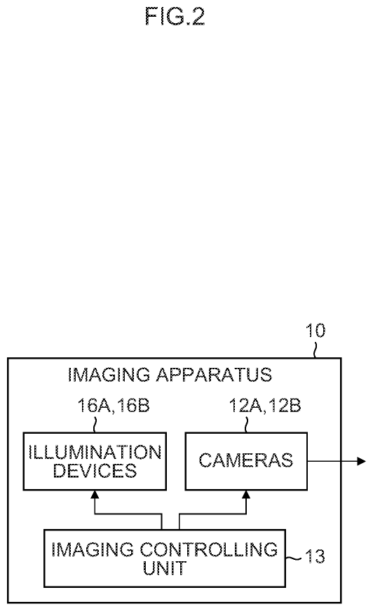

FIG. 2 is a block diagram illustrating a schematic configuration of the imaging apparatus illustrated in FIG. 1.

The imaging apparatus 10 illustrated in FIG. 2 includes: two cameras 12A and 12B that capture images (perform imaging) of medicines; two illumination devices 16A and 16B that illuminate medicines; and an imaging controlling unit (imaging controller) 13.

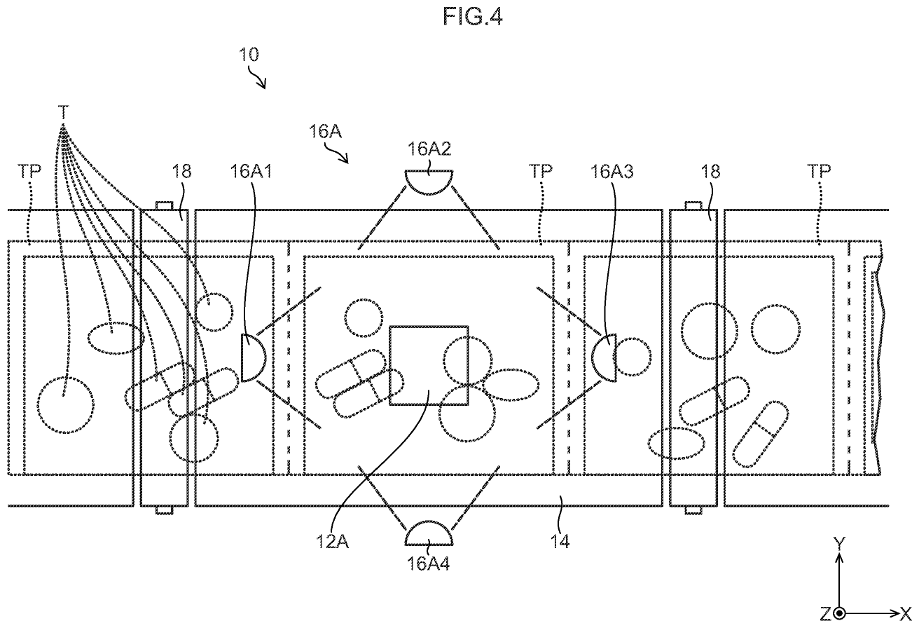

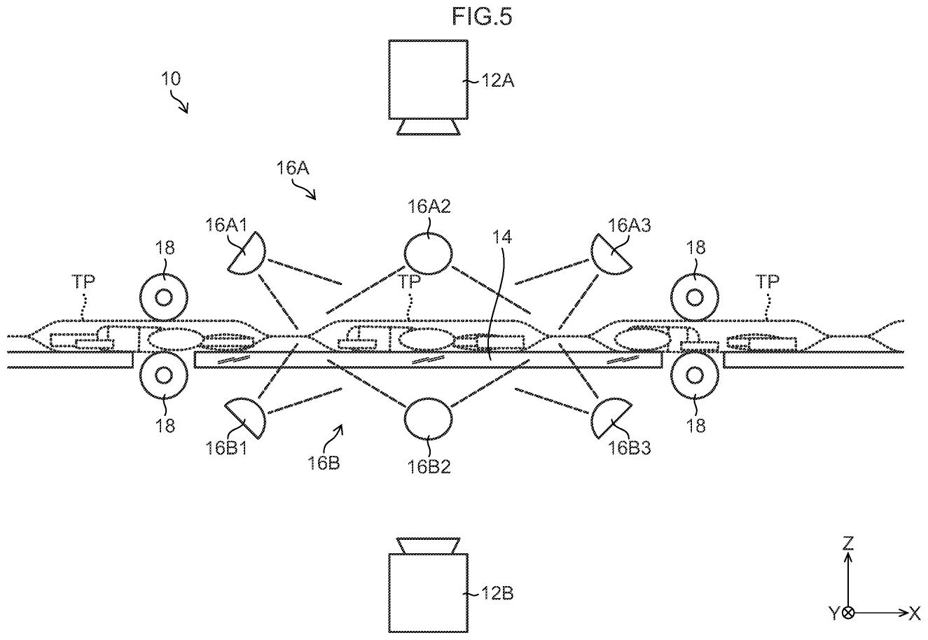

FIGS. 4 and 5 are a plan view and a side view each illustrating a schematic configuration of the imaging apparatus.

Medicine packs TP are connected with one another to form a band (band-like shape). Perforated lines are formed in such a manner that medicine packs TP can be separated from one another.

Each medicine pack TP is placed on a transparent stage 14 disposed horizontally (in the x-y plane).

The cameras 12A and 12B are disposed to face each other via the stage 14 in a direction (z direction) perpendicular to the stage 14. The camera 12A faces a first face (front face) of the medicine pack TP and captures images of the first face of the medicine pack TP. The camera 12B faces a second face (back face) of the medicine pack TP and captures images of the second face of the medicine pack TP. Note that one face of the medicine pack TP that comes into contact with the stage 14 is assumed to be the second face, and another face of the medicine pack TP opposite to the second face is assumed to be the first face.

Among both sides of the stage 14, the illumination device 16A is disposed on the camera 12A side, and the illumination device 16B is disposed on the camera 12B side.

The illumination device 16A is disposed above the stage 14 and emits illumination light to the first face of the medicine pack TP placed on the stage 14. The illumination device 16A, which includes four light emitting units 16A1 to 16A4 disposed radially, emits illumination light from four directions perpendicular to one another. Light emission of the light emitting units 16A1 to 16A4 are individually controlled.

The illumination device 16B is disposed below the stage 14 and emits illumination light to the second face of the medicine pack TP placed on the stage 14. The illumination device 16B, which includes four light emitting units 16B1 to 16B4 disposed radially as with the illumination device 16A, emits illumination light from four directions perpendicular to one another. Light emission of the light emitting units 16B1 to 16B4 are individually controlled.

Imaging (image capturing) is performed as follows. First, the first face (front face) of the medicine pack TP is imaged by using the camera 12A. In imaging, while the light emitting units 16A1 to 16A4 of the illumination device 16A are made to emit light sequentially, four images are captured. Next, while the light emitting units 16A1 to 16A4 are made to emit light at the same time, one image is captured. Next, while the light emitting units 16B1 to 16B4 of the illumination device 16B on the lower side are made to emit light at the same time and a not-illustrated reflector is inserted so as to illuminate the medicine pack TP from below via the reflector, an image of the medicine pack TP is captured from above by using the camera 12A.

Since the four images captured while the light emitting units 16A1 to 16A4 are made to emit sequentially have different illumination directions, in the case in which a medicine has an engraving (convexo-concave) on a surface, a shadow of the engraving appears differently from each other in the four captured images. These four captured images are used to generate an engraving image in which the engraving on the front face side of the medicine T is emphasized.

The one image captured while the light emitting units 16A1 to 16A4 are made to emit light at the same time, is an image having no unevenness in the luminance. For example, the image having no unevenness in the luminance is used to cut out (crop) an image on the front face side of the medicine T (medicine image), and is also a captured image on which the engraving image is to be superimposed.

The image of the medicine pack TP captured from above by using the camera 12A while the medicine pack TP is illuminated from below via the reflector, is a captured image used to recognize areas of the plurality of medicines T.

Next, images of the second face (back face) of the medicine pack TP are captured by using the camera 12B. In image capturing, while the light emitting units 16B1 to 16B4 of the illumination device 16B are made to emit light sequentially, four images are captured, and then, while the light emitting units 16B1 to 16B4 are made to emit light at the same time, one image is captured.

The four captured images are used to generate an engraving image in which an engraving on the back face side of the medicine T is emphasized. The one image captured while the light emitting units 16B1 to 16B4 are made to emit light at the same time is an image having no unevenness in the luminance. For example, the image having no unevenness in the luminance is used to cut out (crop) a medicine image on the back face side of the medicine T, and is also a captured image on which an engraving image is to be superimposed.

The imaging controlling unit 13 illustrated in FIG. 2 controls the cameras 12A and 12B and the illumination devices 16A and 16B so as to perform imaging eleven times for one medicine pack TP (imaging six times with the camera 12A and five times with the camera 12B).

Note that the order of imaging and the number of images for one medicine pack TP are not limited to the above example. In addition, the captured image used to recognize the areas of a plurality of medicines T is not limited to the image of the medicine pack TP captured from above by using the camera 12A while the medicine pack TP is illuminated from below via the reflector. For example, the image captured by the camera 12A while the light emitting units 16A1 to 16A4 are made to emit light at the same time, an image obtained by emphasizing edges in the image captured by the camera 12A while the light emitting units 16A1 to 16A4 are made to emit light at the same time, or the like can be used.

Imaging is performed in a dark room, and the light emitted to the medicine pack TP in the image capturing is only illumination light from the illumination device 16A or the illumination device 16B. Thus, of the eleven captured images as described above, the image of the medicine pack TP captured from above by using the camera 12A while the medicine pack TP is illuminated from below via the reflector, has the color of the light source (white color) in the background and a black color in the area of each medicine T where light is blocked. In contrast, the other ten captured images have a black color in the background and the color of the medicine in the area of each medicine.

Note that even for the image of the medicine pack TP captured from above by using the camera 12A while the medicine pack TP is illuminated from below via the reflector, in the case of transparent medicines the entirety of which are transparent (semitransparent) or capsule medicines (partially transparent medicine) in which part or all of the capsule is transparent and the capsule is filled with powder or granular medicine, the areas of medicines transmit light and thus are not deep black, unlike in the case of opaque medicines.

Returning to FIG. 5, the medicine pack TP is nipped by rotating rollers 18 and conveyed to the stage 14. The medicine pack TP is leveled in the course of conveyance, and overlapping is eliminated. In the case of a medicine pack band which are a plurality of medicine packs TP connected with one another to form a band, after imaging for one medicine pack TP is finished, the medicine pack band is conveyed in the longitudinal direction (x direction) by a length of one pack, and then imaging is performed for the next medicine pack TP.

The object recognition apparatus 20 illustrated in FIG. 1 is configured to recognize, from an image in which images of a plurality of medicines are captured, each of the plurality of medicines. In particular, the object recognition apparatus 20 recognizes the area of each medicine T present in the captured image.

Hence, the image acquiring unit 22 of the object recognition apparatus 20 acquires a captured image to be used for recognizing the areas of a plurality of medicines T (specifically, the image of the medicine pack TP captured from above by using the camera 12A while the medicine pack TP is illuminated from below via the reflector), of the eleven images captured by the imaging apparatus 10.

The CPU 24, using the RAM 26 as a work area, uses various programs including an object recognition program and parameters stored in the ROM 28 or a not-illustrated hard disk apparatus, and executes software while using the parameters stored in the ROM 28 or the like, so as to execute various processes of the object recognition apparatus 20.

The operating unit 25 including a keyboard, a mouse, and the like, is a part through which various kinds of information and instructions are inputted by the user's operation.

The displaying unit 29 displays a screen necessary for operation of the operating unit 25, functions as a part that implements a graphical user interface (GUI), and is capable of displaying a recognition result of a plurality of objects and other information.

Note that the CPU 24, the RAM 26, the ROM 28, and the like in this example are included in a processor, and the processor performs various processes described below.

[Object Recognition Apparatus of First Embodiment]

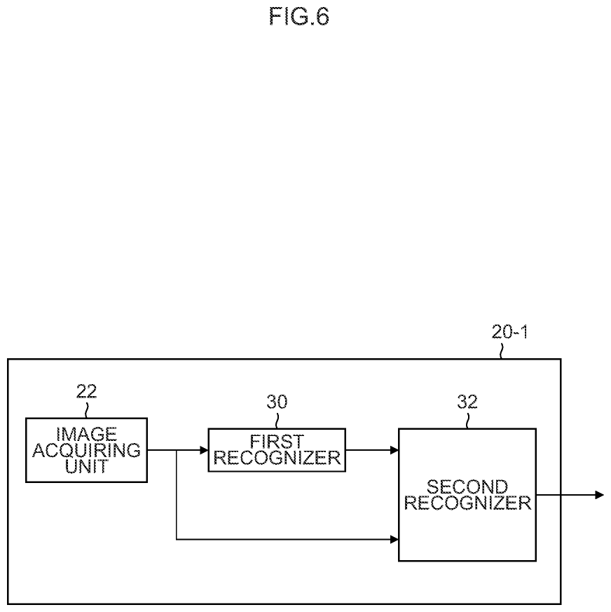

FIG. 6 is a block diagram of an object recognition apparatus according to a first embodiment of the present invention.

FIG. 6 is a functional block diagram is an object recognition apparatus 20-1 according to the first embodiment, and illustrates the functions executed by the hardware configuration of the object recognition apparatus 20 illustrated in FIG. 1. The object recognition apparatus 20-1 includes the image acquiring unit 22, a first recognizer 30, and a second recognizer 32.

The image acquiring unit 22 acquires the captured image to be used for recognizing the areas of a plurality of medicines T, from the imaging apparatus 10 (performs an image acquiring process), as described above.

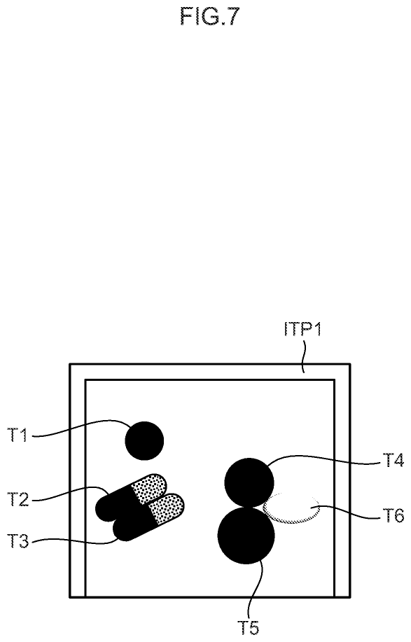

FIG. 7 is a diagram illustrating an example of the captured image that the image acquiring unit acquires.

The captured image ITP1 illustrated in FIG. 7 is an image of a medicine pack TP (the medicine pack TP shown in the center in FIGS. 3 and 4) captured from above by using the camera 12A while the medicine pack TP is illuminated from below via the reflector. The medicine pack TP has six medicines T (T1 to T6) packaged therein.

The medicine T1 illustrated in FIG. 7 is isolated from the other medicines T2 to T6. The capsule medicines T2 and T3 are in line-contact with each other. The medicines T4 to T6 are in point-contact with one another. The medicine T6 is a transparent medicine.

The first recognizer 30 illustrated in FIG. 6 receives the captured image ITP1 acquired by the image acquiring unit 22, and performs an edge-image acquiring process for acquiring an edge image from the captured image ITP1. The edge image indicates one or more parts where two or more medicines of the plurality of medicines T1 to T6 are in point-contact or line-contact with one another, only.

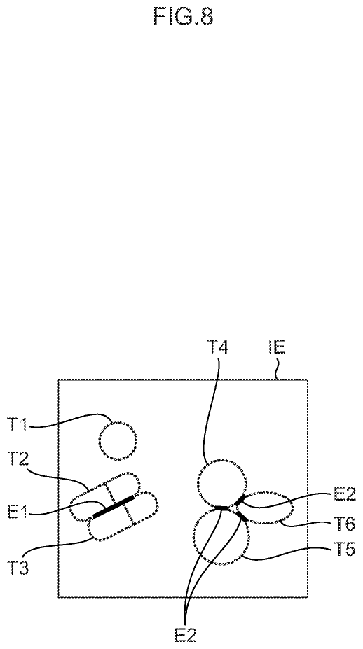

FIG. 8 is a diagram illustrating an example of the edge image acquired by the first recognizer, which indicates only the parts where the plurality of medicines are in point-contact or line-contact.

The edge image IE illustrated in FIG. 8 indicates only the parts E1 and E2 at which two or more medicines of the plurality of medicines T1 to T6 are in point-contact or line-contact with one another. The edge image IE is an image indicated by solid lines in FIG. 8. Note that the areas indicated by dotted lines in FIG. 8 are the areas in which the plurality of medicines T1 to T6 are present.

The edge image of the part E1 indicating line-contact is an image at which the capsule medicines T2 and T3 are in line-contact with each other. The edge images of the parts E2 indicating point-contact are images at which the three medicines T4 to T6 are in point-contact with one another.

<First Recognizer>

The first recognizer 30 may include a machine-learning trained model (first trained model) which has been trained by machine learning based on learning data (first learning data) shown below.

<<Learning Data (First Learning Data) and Method of Generating Same>>

The first learning data is learning data including pairs of a leaning image (first learning image) and a correct data (first correct data). The first learning image is a captured image that includes a plurality of objects (in this example, “medicines”), in which two or more medicines of the plurality of medicines are in point-contact or line-contact with one another. The first correct data is an edge image that indicates only the parts where two or more objects of the plurality of objects are in point-contact or line-contact in the first learning image.

A large number of captured images ITP1 as illustrated in FIG. 7 are prepared as first learning images. The captured images ITP1 are different from one another in terms of the arrangement of a plurality of medicines, the kinds of medicines, the number of medicines, and other factors. The first learning images are captured images in which two or more medicines of the plurality of medicines are in point-contact or line-contact with one another. In this case, the medicines are not necessarily packaged in medicine packs.

Then, correct data (first correct data) corresponding to each first learning image is prepared. Each first learning image is displayed on a display, a user visually checks the parts at which two or more medicines are in point-contact or line-contact with one another in the first learning image, and specifies the parts where medicines are in point-contact or line-contact using a pointing device, to generate first correct data.

FIG. 8 is a diagram illustrating an example of an edge image indicating only the parts where medicines are in point-contact or line-contact with one another.

In a case in which a captured image ITP1 illustrated in FIG. 7 is used as a first learning image, the edge image IE illustrated in FIG. 8 is used as the first correct data, and pairs of the first learning image (captured image ITP1) and the first correct data (edge image IE) is used as first learning data.

Since the first correct data can be generated by indicating, with a pointing device, the parts at which two or more medicines are in point-contact or line-contact with one another, it is easier to generate than in a case in which correct data (correct images) for object recognition is generated by filling the areas of objects.

The amount of the first learning data can be increased by the following method.

One first learning image and information indicating the areas of the medicines in the first learning image (for example, a plurality of mask images for cutting out an image of each of the plurality of medicines from the first learning image) are prepared. A user fills the area of each medicine to generate a plurality of mask images.

Next, a plurality of medicine images are acquired by cutting out the areas of the plurality of medicines from the first learning image by using the plurality of mask images.

The plurality of medicine images thus acquired are arbitrarily arranged to prepare a large number of first learning images. In this case, medicine images are moved in parallel or rotated so that two or more medicines of the plurality of medicines are in point-contact or line-contact with one another.

Since the arrangement of the medicine images in the first learning images generated as described above is known, the parts at which two or more medicines of the plurality of medicines are in point-contact or line-contact with one another are also known. Hence, edge images (first correct data) indicating only the parts where medicines are in point-contact or line-contact can be automatically generated for the generated first learning images.

Note that in a case where a plurality of medicine images are arbitrarily arranged, it is preferable that the medicine images of transparent medicines (for example, the medicine T6 illustrated in FIG. 7) be fixed, and that the other medicine images be arbitrarily arranged. This is because light passing through transparent medicines changes depending on the positions of transparent medicines in image capturing areas and their orientations, and thereby the medicine images of the transparent medicines change.

In this manner, a large amount of first learning data can be generated by using a small number of first learning images, and mask images respectively indicating the areas of medicines within the first learning images.

The first recognizer 30 may be implemented using a first machine-learning trained model trained by machine learning based on the first learning data generated as described above.

The first trained model may include, for example, a trained model constituted by using a convolutional neural network (CNN).

Returning FIG. 6, in a case where the first recognizer 30 receives a captured image (for example, the captured image ITP1 illustrated in FIG. 7) acquired by the image acquiring unit 22, the first recognizer 30 outputs, as a recognition result, an edge image (the edge image IE illustrated in FIG. 8) indicating only the parts where medicines are in point-contact or line-contact with one another, of the plurality of medicines (T1 to T6) in the captured image ITP1.

Specifically, in a case where the first recognizer 30 receives the captured image acquired by the image acquiring unit 22 (for example, the captured image ITP1 illustrated in FIG. 7), the first recognizer 30 performs area classification (segmentation) of the parts where medicines are in point-contact or line-contact, in units of pixels in the captured image ITP1, or in units of pixel blocks respectively including several pixels. For example, the first recognizer 30 assigns “1” to each of the pixels in the parts where medicines are in point-contact or line-contact and “0” to each of the other pixels. Then, the first recognizer 30 outputs, as a recognition result, a binary edge image (the edge image IE illustrated in FIG. 8) indicating only the parts where medicines are in point-contact or line-contact in the plurality of medicines (T1 to T6).

<Second Recognizer>

The second recognizer 32, receives the captured image ITP1 acquired by the image acquiring unit 22 and the edge image IE recognized by the first recognizer 30, recognizes each of the plurality of objects (medicines T) imaged (image-captured) in the captured image ITP1 and outputs the recognition result.

The second recognizer 32 may be implemented using a second machine-learning trained model (second trained model) trained by machine learning based on learning data (second learning data) shown below.

<<Learning Data (Second Learning Data) and Method of Generating Same>>

The second learning data is learning data including pairs of: a learning image (second learning image); and second correct data for the learning image. Each of the second learning image has: a captured image which includes a plurality of objects (in this example, “medicines”) and in which two or more medicines of the plurality of medicines are in point-contact or line-contact with one another; and an edge image indicating only the parts where medicines are in point-contact or line-contact in the captured image. The correct data (second correct data) is area information indicating areas of the plurality of medicines in the captured image.

The amount of the second learning data can be increased by using the same method as that for the first learning data.

The second recognizer 32 may include a second machine-learning trained model trained by machine learning based on the second learning data generated as described above.

The second trained model may include, for example, a trained model constituted by using a CNN (Convolutional Neural Network).

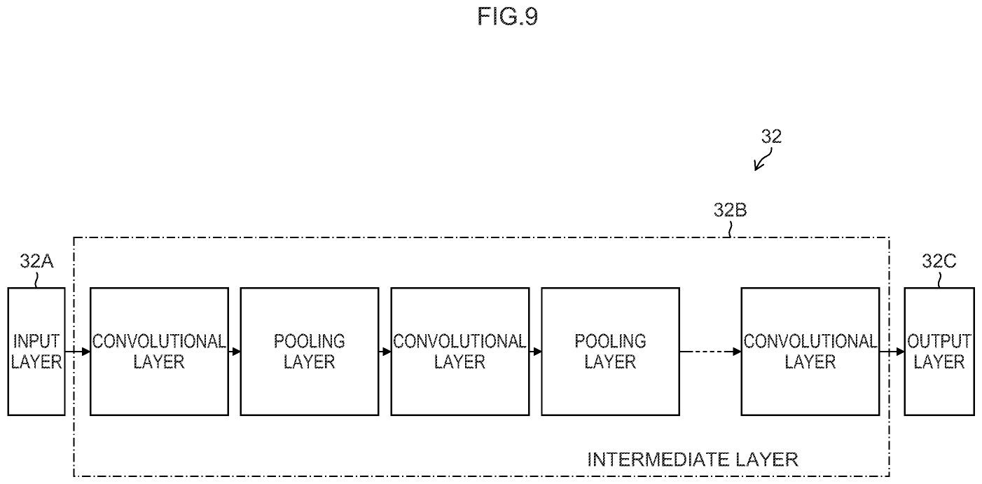

FIG. 9 is a schematic diagram illustrating an example of a typical configuration of a CNN which is one example of a trained model constituting the second recognizer (second trained model).

The second recognizer 32 has a layered structure including a plurality of layers and holds a plurality of weight parameters. When the weight parameters are set to optimum values, the second recognizer 32 becomes the second trained model and functions as a recognizer.

As illustrated in FIG. 9, the second recognizer 32 includes: an input layer 32A; an intermediate layer 32B including a plurality of convolutional layers and a plurality of pooling layers; and an output layer 32C. The second recognizer 32 has a structure in which a plurality of “nodes” in each layer are connected with “edges”.

The second recognizer 32 in this example is a trained model that performs segmentation to individually recognize the areas of the plurality of medicines captured in the captured image. The second recognizer 32 performs area classification (segmentation) of the medicines in units of pixels in the captured image ITP1 or in units of pixel blocks each of which includes several pixels. For example, the second recognizer 32 outputs a mask image indicating the area of each medicine, as a recognition result.

The second recognizer 32 is designed based on the number of medicines that can be put in a medicine pack TP. For example, in a case in which the medicine pack TP can accommodate 25 medicines at maximum, the second recognizer 32 is configured to recognize areas of 30 medicines at maximum including margins and output the recognition result.

The input layer 32A of the second recognizer 32 receives the captured image ITP1 acquired by the image acquiring unit 22 and the edge image IE recognized by the first recognizer 30, as input images (see FIGS. 7 and 8).

The intermediate layer 32B is a part that extracts features from input images inputted from the input layer 32A. The convolutional layers in the intermediate layer 32B perform filtering on nearby nodes in the input images or in the previous layer (perform a convolution operation using a filter) to acquire a “feature map”. The pooling layers reduce (or enlarge) the feature map outputted from the convolutional layer to generate a new feature map. The “convolutional layers” play a role of feature extraction such as edge extraction from an image. The “pooling layers” play a role of giving robustness so that the extracted features are not affected by parallel shifting or the like. Note that the intermediate layer 32B is not limited to ones in which a convolutional layer and a pooling layer form one set. The intermediate layer 32B may include consecutive convolutional layers or a normalization layer.

The output layer 32C is a part that recognizes each of the areas of the plurality of medicines captured in the captured image ITP1, based on the features extracted by the intermediate layer 32B and outputs, as a recognition result, information indicating the area of each medicine (for example, bounding box information for each medicine that surrounds the area of a medicine with a rectangular frame).

The coefficients of filters and offset values applied to the convolutional layers or the like in the intermediate layer 32B of the second recognizer 32 are set to optimum values using data sets of the second learning data including pairs of the second learning image and the second correct data.

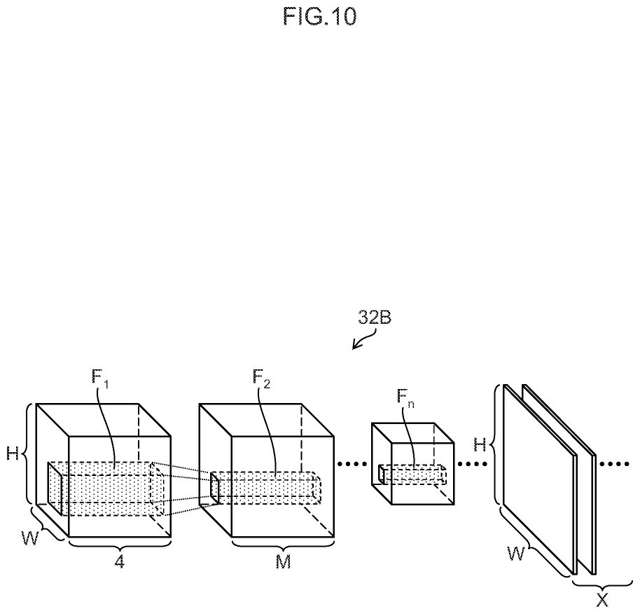

FIG. 10 is a schematic diagram illustrating a configuration example of the intermediate layer of the second recognizer illustrated in FIG. 9.

The first convolutional layer illustrated in FIG. 10 performs a convolution operation on input images for recognition, with a filter F₁. Here, among the input images, the captured image ITP1 is, for example, an image of RGB channels (three channels) of red (R), green (G), and blue (B) having an image size of a vertical dimension H and a horizontal dimension W. Among the input images, the edge image IE is an image of one channel having an image size of a vertical dimension H and a horizontal dimension W.

Thus, the first convolutional layer illustrated in FIG. 10 performs a convolution operation on the images of four channels, each of which has an image size of a vertical dimension H and a horizontal dimension W, with the filter F₁. Since the input images have four channels (four sheets), for example, in a case where a filter having a size of 5×5 is used, the filter size of the filter F₁ is 5×5×4.

With the convolution operation using the filter F₁, one channel (one sheet) of a “feature map” is generated for the one filter F₁. In the example illustrated in FIG. 10, M filters F₁ are used to generate M channels of “feature maps”.

As for the filter F₂ used in the second convolutional layer, in a case where, for example, a filter having a size of 3×3 is used, the filter size of the filter F₂ is 3×3×M.

The reason why the size of the “feature map” in the n-th convolutional layer is smaller than the size of the “feature map” in the second convolutional layer is that the size is down-scaled by the convolutional layers up to the previous stage.

The first half part of the convolutional layers of the intermediate layer 32B play a role of extraction of feature amounts, and the second half part of the convolutional layers play a role of detection of the areas of objects (medicines). Note that the second half part of the convolutional layers performs up-scaling, and a plurality of sheets (in this example, 30 sheets) of “feature maps” having the same size as the input images are outputted at the last convolutional layer. However, among the 30 sheets of “feature maps”, X sheets are actually meaningful, and the remaining (30−X) sheets are meaningless feature maps filled with zeros.

Here, X of the X sheets corresponds to the number of detected medicines. Based on the “feature maps”, it is possible to acquire information (bounding box information) on a bounding box surrounding the area of each medicine.

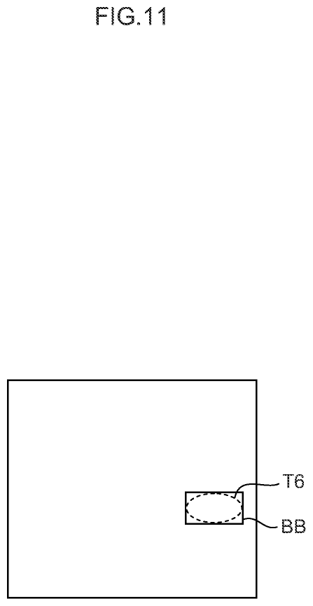

FIG. 11 is a diagram illustrating an example of a recognition result by the second recognizer.

The second recognizer 32 outputs bounding boxes BB that surround the areas of medicines with rectangular frames as a recognition result of medicines. The bounding box BB illustrated in FIG. 11 corresponds to the transparent medicine (medicine T6). Uses of the information (bounding box information) indicated by the bounding box BB makes it possible to cut out (crop) only the image (medicine image) of the area of the medicine T6 from the captured image in which the plurality of medicines are imaged.

Even in a case where the transparent medicine T6 is in contact with the medicines T4 and T5 as illustrated in FIG. 7, it is possible to separate the area of the transparent medicine T6 from the areas of the other medicines with high accuracy and recognize the area of the transparent medicine T6 as the bounding box BB in FIG. 11 shows.

Note that the second recognizer 32 in this example receives the edge image IE as a channel separate from the channels for the captured image ITP1. However, the second recognizer 32 may receive the edge image IE as an input image of a system separate from the captured image ITP1, or may receive an input image in which the captured image ITP1 and the edge image IE are synthesized.

As the trained model of the second recognizer 32, for example, R-CNN (regions with convolutional neural networks) may be used.

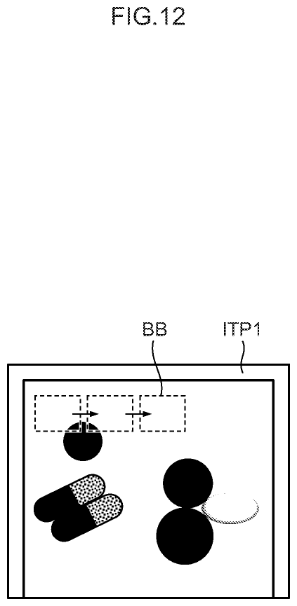

FIG. 12 is a diagram illustrating an object recognition process by R-CNN.

In R-CNN, a bounding box BB having a varying size is slid in the captured image ITP1, and an area of the bounding box BB that can surround an object (in this example, a medicine) is detected. Then, only an image part in the bounding box BB is evaluated (CNN feature amount is extracted) to detect edges of the medicine. The range in which the bounding box BB is slid in the captured image ITP1 does not necessarily have to be the entire captured image ITP1.

Here, instead of R-CNN, Fast R-CNN, Faster R-CNN, Mask R-CNN, or the like may be used.

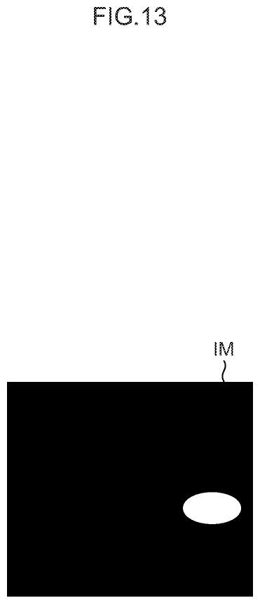

FIG. 13 is a diagram illustrating a mask image of a medicine recognized by Mask R-CNN.

In addition to detection of the bounding boxes BB each of which surrounds the area of the medicine with a rectangle shape, the Mask R-CNN may perform area classification (segmentation) on the captured image ITP1 in units of pixels and output mask images IM for each medicine image (for each object image). Each of mask images IM indicates the area of each medicine.

The mask image IM illustrated in FIG. 13 corresponds to the area of the transparent medicine T6. The mask image IM may be used for a mask process to cut out a medicine image (image of only the area of the transparent medicine T6), which is an object image, from a captured image other than the captured image ITP1.

Mask R-CNN that performs such recognition can be implemented by machine learning using the second learning data for training the second recognizer 32. Note that even in a case where the amount of data of the second learning data is small, a desired trained model can be obtained by training an existing Mask R-CNN with transfer learning (also called “fine tuning”), using the second learning data for training the second recognizer 32.

In addition, the second recognizer 32 may output edge information for each medicine image indicating the edges of the area of each medicine image, in addition to bounding box information for each medicine image and a mask image, as a recognition result.

In addition to the captured image ITP1, the second recognizer 32 receives information useful to separate the areas of medicines (the edge image IE indicating only the parts where medicines are in point-contact or line-contact with one another) and recognizes the area of each medicine. Thus, even in a case in which the captured image ITP1 includes a plurality of medicines and the areas of two or more of the medicines of the plurality of medicines are in point-contact or line-contact with one another, it is possible to separate and recognize the areas of the plurality of medicines with high accuracy and output (output process) the recognition result.

The recognition result of each medicine by the object recognition apparatus 20-1 (for example, a mask image for each medicine) is sent, for example, to a not-illustrated apparatuses such as a medicine audit apparatus or a medicine identification apparatus and used for a mask process to cut out medicine images from captured images, other than the captured image ITP1, captured by the imaging apparatus 10.

Cut-out medicine images are used by a medicine audit apparatus, a medicine identification apparatus, or the like for medicine audits or medicine identification. Further, in order to support identification of medicines by a user, the cut-out medicine images may be used to generate medicine images on which the medicines' engravings or the like can be easily recognized visually, and the generated medicine images may be aligned and displayed.

[Object Recognition Apparatus According to Second Embodiment]

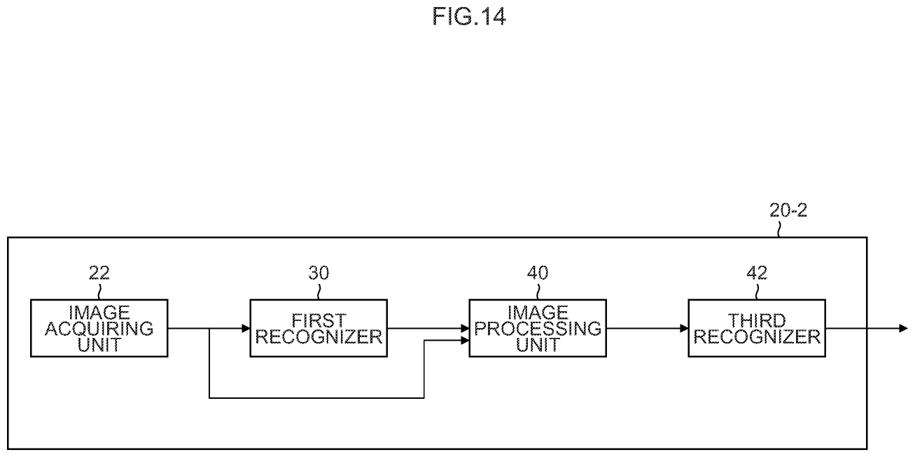

FIG. 14 is a block diagram of an object recognition apparatus according to a second embodiment of the present invention.

FIG. 14 is a functional block diagram of an object recognition apparatus 20-2 according to the second embodiment. The functions are executed by the hardware configuration of the object recognition apparatus 20 illustrated in FIG. 1. The object recognition apparatus 20-2 includes an image acquiring unit 22, a first recognizer 30, an image processing unit 40, and a third recognizer 42. In FIG. 14, the parts common to those in the object recognition apparatus 20-1 according to the first embodiment illustrated in FIG. 6 are denoted by the same reference numerals, and detailed description thereof is omitted.

The object recognition apparatus 20-2 according to the second embodiment illustrated in FIG. 14 is different from the object recognition apparatus 20-1 according to the first embodiment in that the object recognition apparatus 20-2 includes the image processing unit 40 and the third recognizer 42, instead of the second recognizer 32.

The image processing unit 40 receives the captured image acquired by the image acquiring unit 22 and the edge image recognized by the first recognizer 30, and performs image processing to replace the parts corresponding to the edge image (the parts where medicines are in point-contact or line-contact with one another) in the captured image, with the background color of the captured image.

Now, in the case in which the background color of the areas of the plurality of medicines T1 to T6 captured in the captured image ITP1 acquired by the image acquiring unit 22 is white, as illustrated in FIG. 7, the image processing unit 40 performs image processing to replace the parts E1 and E2 of the captured image ITP1, at which the medicines are in point-contact or line-contact with one another in the edge image IE illustrated in FIG. 8, with the background color of white.

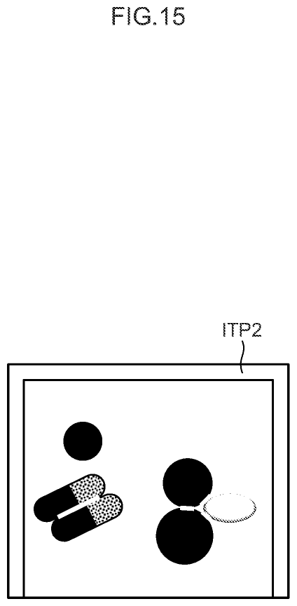

FIG. 15 is a diagram illustrating a captured image which has been subjected to the image processing by the image processing unit.

The captured image ITP2 after the image processing by the image processing unit 40 is different from the captured image ITP1 (FIG. 7) before the image processing in that each of the areas of the six medicines T1 to T6 is separated from one another, without being in point-contact or line-contact with the others.

The captured image ITP2 which has been subjected to the image processing by the image processing unit 40 is outputted to the third recognizer 42.

The third recognizer 42 receives the captured image ITP2 after the image processing, recognizes each of the plurality of objects (medicines) included in the captured image ITP2, and outputs the recognition result.

The third recognizer 42 may include a machine-learning trained model (third trained model) trained by machine learning based on typical learning data. For example, Mask R-CNN or the like may be used for constituting the third recognizer 42.

Here, typical learning data means learning data including pairs of a learning image and a correct data. The learning image is a captured image including one or more objects (in this example, “medicines”), and the correct data is area information indicating areas of the medicines included in the learning image. Note that the number of medicines included in a captured image may be one or plural. In a case in which a plurality of medicines are included in a captured image, the plurality of medicines may be separated from one another, or all or some of the plurality of medicines may be in point-contact or line-contact with one another.

Since the captured image ITP2 including a plurality of objects (in this example, “medicines”) and inputted to the third recognizer 42, has already been subjected to the pretreatment by the image processing unit 40 so as to separate the parts where medicines are in point-contact or line-contact, the third recognizer 42 can recognize the area of each medicine with high accuracy.

[Object Recognition Method]

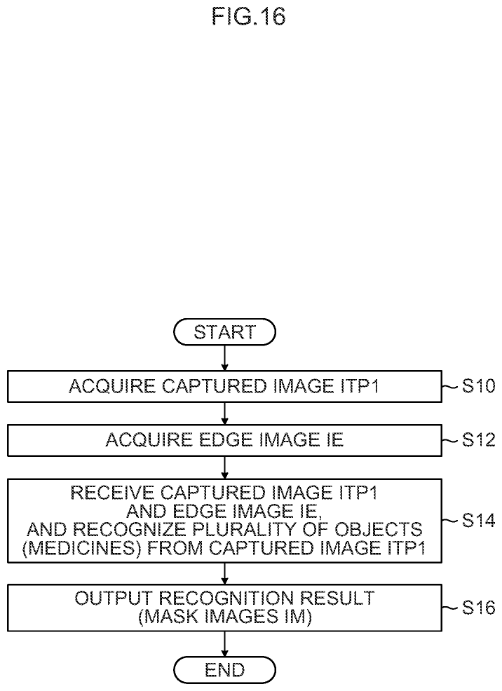

FIG. 16 is a flowchart showing an object recognition method according to the embodiments of the present invention.

The process of each step illustrated in FIG. 16 is performed, for example, by the object recognition apparatus 20-1 (processor) illustrated in FIG. 6.

In FIG. 16, the image acquiring unit 22 acquires, from the imaging apparatus 10, a captured image in which two or more medicines of a plurality of objects (medicines) are in point-contact or line-contact with one another (for example, the captured image ITP1 illustrated in FIG. 7) (step S10). Note that it goes without saying that the captured images ITP1 acquired by the image acquiring unit 22 include ones in which the areas of a plurality of medicines T1 to T6 are not in point-contact or line-contact.

The first recognizer 30 receives the captured image ITP1 acquired at step S10 and generates (acquires) an edge image IE indicating only the parts where medicines are in point-contact or line-contact with one another, in the captured image ITP1 (step S12, see FIG. 8). Note that in a case in which areas of all the medicines (T1 to T6) captured in a captured image ITP1 acquired by the image acquiring unit 22 are not in point-contact or line-contact with one another, the edge image IE outputted from the first recognizer 30 has no edge information.

The second recognizer 32 receives the captured image ITP1 acquired in step S10 and the edge image IE generated in step S12, recognizes each of the plurality of objects (medicines) from the captured image ITP1 (step S14), and outputs the recognition result (for example, the mask image IM indicating the area of a medicine illustrated in FIG. 13) (step S16).

[Others]

Although objects to be recognized in the present embodiments are a plurality of medicines, the objects are not limited to medicines. Objects to be recognized may be anything so long as a plurality of objects are imaged at the same time and two or more of the plurality of objects may be in point-contact or line-contact with one another.

In the object recognition apparatus according to the present embodiments, the hardware structure of the processing unit (processor) such as the CPU 24 or the like, for example, that executes various processes is various processors shown as follows. Examples of the various processors include: a central processing unit (CPU) that is a general purpose processor configured to function as various processing units by executing software (programs); a programmable logic device (PLD) that is a processor whose circuit configuration can be changed (modified) after production such as a field programmable gate array (FPGA); and a dedicated electrical circuit or the like that is a processor having a circuit configuration uniquely designed for executing specific processes such as an application specific integrated circuit (ASIC).

One processing unit may be configured by using one of these various processors or may be configured by using two or more of the same kind or different kinds of processors (for example, a plurality of FPGAs, or a combination of a CPU and an FPGA). In addition, a plurality of processing units may be implemented in one processor. Firstly, there may be a configuration in which a plurality of processing units are included in one processor and the processor includes a combination of one or more CPUs and software as typified by a computer such as a client or a server, and the processor functions as a plurality of processing units. Secondly, there may be a configuration using a processor which realizes functions of the entire system including a plurality of processing units, using one integrated circuit (IC) chip as typified by a system on chip (SoC) or the like. As described above, various processing units are configured, as a hardware structure, by using one or more of the various processors described above.

The hardware structures of these various processors are, more specifically, electrical circuitry formed by combining circuit elements such as semiconductor elements.

The present invention also includes an object recognition program that, by being installed in a computer, implements various functions as an object recognition apparatus according to the present invention and a recording medium on which the object recognition program is recorded.

Further, the present invention is not limited to the foregoing embodiments, and it goes without saying that various changes are possible within a scope not departing from the spirits of the present invention.

### REFERENCE SIGNS LIST

10 imaging apparatus

12A, 12B camera

13 imaging controlling unit

14 stage

16A, 16B illumination device

16A1 to 16A4, 16B1 to 16B4 light emitting unit

18 roller

20, 20-1, 20-2 object recognition apparatus

22 image acquiring unit

24 CPU

25 operating unit

26 RAM

28 ROM

29 displaying unit

30 first recognizer

32 second recognizer

32A input layer

32B intermediate layer

32C output layer

40 image processing unit

42 third recognizer

BB bounding box

IE edge image

IM mask image

ITP1, ITP2 captured image

S10 to S16 step

T, T1 to T6 medicine

TP medicine pack

What is claimed is:

1. An object recognition apparatus comprising a processor, which recognizes, by using the processor, each of a plurality of objects from a captured image in which images of the plurality of objects are captured, wherein
the processor is configured to perform:
an image acquiring process to acquire the captured image in which two or more objects of the plurality of objects are in point-contact or line-contact with one another;
an edge-image acquiring process to acquire an edge image indicating only a part where the two or more objects are in point-contact or line-contact with one another in the captured image; and
an output process to receive the captured image and the edge image, recognize each of the plurality of objects from the captured image, and output a recognition result.

2. The object recognition apparatus according to claim 1, wherein
the processor includes a first recognizer configured to perform the edge-image acquiring process, and
in a case where the first recognizer receives a captured image in which two or more objects of the plurality of objects are in point-contact or line-contact with one another, the first recognizer outputs an edge image indicating only the part where the two or more objects are in point-contact or line-contact with one another in the captured image.

3. The object recognition apparatus according to claim 2, wherein
the first recognizer is a first machine-learning trained model trained by machine learning based on first learning data including pairs of a first learning image and first correct data,
the first learning image is a captured image which includes a plurality of objects and in which two or more objects of the plurality of objects are in point-contact or line-contact with one another, and
the first correct data is an edge image indicating only a part where the two or more objects are in point-contact or line-contact with one another in the first learning image.

4. The object recognition apparatus according to claim 1, wherein
the processor includes a second recognizer configured to receive the captured image and the edge image, recognize each of the plurality of objects included in the captured image, and output a recognition result.

5. The object recognition apparatus according to claim 4, wherein
the second recognizer is a second machine-learning trained model trained by machine learning based on second learning data including pairs of a second learning image and second correct data,
the second learning image has: a captured image which includes a plurality of objects and in which two or more objects of the plurality of objects are in point-contact or line-contact with one another; and an edge image indicating only a part where the two or more objects are in point-contact or line-contact with one another in the captured image, and
the second correct data is area information indicating areas of the plurality of objects in the captured image.

6. The object recognition apparatus according to claim 1, wherein
the processor includes a third recognizer,
the processor is configured to receive the captured image and the edge image, and perform image processing that replaces a part of the captured image corresponding to the edge image with a background color of the captured image, and
the third recognizer is configured to receive the captured image which has been subjected to the image processing, recognize each of the plurality of objects included in the captured image, and output a recognition result.

7. The object recognition apparatus according to claim 1, wherein
in the output process, the processor outputs, as the recognition result, at least one of: a mask image for each object image indicating each object, the mask image to be used for a mask process to cut out each object image from the captured image; bounding box information for each object image, which surrounds an area of each object image with a rectangle; and edge information for each object image, which indicates an edge of the area of each object image.

8. The object recognition apparatus according to claim 1, wherein
the plurality of objects are a plurality of medicines.

9. Learning Data comprising pairs of a first learning image and first correct data, wherein
the first learning image is a captured image which includes a plurality of objects and in which two or more objects of the plurality of objects are in point-contact or line-contact with one another, and
the first correct data is an edge image indicating only a part where the two or more objects are in point-contact or line-contact with one another in the first learning image.

10. Learning Data comprising pairs of a second learning image and second correct data, wherein
the second learning image has: a captured image which includes a plurality of objects and in which two or more objects of the plurality of objects are in point-contact or line-contact with one another; and an edge image indicating only a part where the two or more objects are in point-contact or line-contact with one another in the captured image, and
the second correct data is area information indicating areas of the plurality of objects in the captured image.

11. An object recognition method of recognizing each of a plurality of objects from a captured image in which images of the plurality of objects are captured, the method comprising:
acquiring, by a processor, the captured image in which two or more objects of the plurality of objects are in point-contact or line-contact with one another;
acquiring, by a processor, an edge image indicating only a part where the two or more objects are in point-contact or line-contact with one another in the captured image; and
receiving, by a processor, the captured image and the edge image, recognizing each of the plurality of objects from the captured image, and outputting a recognition result.

12. The object recognition method according to claim 11, wherein
in the outputting the recognition result, at least one of: a mask image for each object image indicating each object, the mask image to be used for a mask process to cut out each object image from the captured image; bounding box information for each object image, which surrounds an area of each object image with a rectangle; and edge information for each object image, which indicates an edge of the area of each object image, is output as the recognition result.

13. The object recognition method according to claim 11, wherein
the plurality of objects are a plurality of medicines.

14. A non-transitory computer-readable, tangible recording medium which records thereon a program for causing, when read by a computer, the computer to perform the object recognition method according to claim 11.
